(19) United States
(12) Patent Application Publication
(10) Pub. No.: US 2012/0037557 A1
(43) Pub. Date: Feb. 16, 2012

(54) Filter

(76) Inventors: Welby S. Atteberry, Albion, IL (US); David E. Hahn, Albion, IL (US); John D. Gaither, West Salem, IL (US); John W. Stockhowe, JR., Carmi, IL (US)

(21) Appl. No.: 13/208,145

(22) Filed: Aug. 11, 2011

Related U.S. Application Data
(60) Provisional application No. 61/373,136, filed on Aug. 12, 2010.

(51) Int. Cl. B01D 29/15; B01D 35/00; B01D 35/30

(52) U.S. Cl. 210/234; 210/443

(57) ABSTRACT

The filter may include a first end cap, a second end cap, and a filter media. The filter media may be located between the first end cap and the second end cap. The filter media and the end caps may be located in a shell. An insert including a projection may be connected to the shell. The projection may engage a valve in the filter head when the filter is mounted onto a filter head. The projection may include a curved portion. The curved portion may engage a ball in the valve. The filter media may be a coalescing media which may assist in separating water from a fuel and water mixture.

### CROSS-REFERENCE TO RELATED APPLICATIONS

This patent application claims the benefit of U.S. Provisional Patent Application No. 61/373,136, filed Aug. 12, 2010, which is incorporated by reference.

### BACKGROUND OF THE INVENTION

Filters may be used to separate contaminants from a fluid. The contaminants may be particulate matter and/or other undesirable fluids. Filters may be used for many different applications. One application may be used for filtering fluids in vehicles, such as, trucks and automobiles. Examples of fluids which may be filtered may include fuel, oil, coolant, and other fluids. Examples of fuels may include diesel, bio-diesel, and gasoline. One potential use for a filter may be to separate water from a fuel, such as, separating water from bio-diesel.

The filter may be mounted onto a filter head. In some situations, the filter head may include a valve which may prevent the flow of fluid when the filter is not mounted to the filter head. The filter may include a projection which may engage the valve and allow the fluid to flow through the filter.

### BRIEF SUMMARY OF THE INVENTION

The filter may include a first end cap, a second end cap, and a filter media. The filter media may be located between the first end cap and the second end cap. The filter media and the end caps may be located in a shell. An insert including a projection may be connected to the shell. The projection may engage a valve in the filter head when the filter is mounted onto a filter head. The projection may include a curved portion. The curved portion may engage a ball in the valve.

The filter media may be a coalescing media which may assist in separating water from a fuel and water mixture. The fuel and water mixture may enter the filter through an inlet opening. The fuel and water mixture may travel through the filter media. The filter media may aid in separating the water from the fuel. The water may sink to the bottom of the filter and the fuel may flow upward and through the outlet in the filter.

### BRIEF DESCRIPTION OF THE DRAWINGS

FIG. 1 is a perspective view of a filter.

FIG. 2 is an exploded perspective view of the filter in FIG. 1.

FIG. 3 is a top view of the filter in FIG. 1.

FIG. 4 is a cross-sectional view taken along line 4-4 in FIG. 3.

FIG. 5 is a side view of a second end cap.

FIG. 6 is a cross-sectional view taken along line 6-6 of FIG. 5.

FIG. 7 is a perspective view an insert.

FIG. 8 is a top view of the insert in FIG. 7.

FIG. 9 is a cross-sectional schematic representation of the fluid flow of the filter with a water sensor attached to the filter.

FIG. 10 is a cut away view of the filter attached to a filter head and a water sensor attached to the filter.

FIG. 11 is a cut away view of another embodiment.

FIG. 12 is a cut away view of another embodiment.

FIG. 13 is a cut away view of another embodiment.

FIG. 14 is a cut away view of another embodiment.

FIG. 15 is a perspective view of the insert and shield in FIG. 14.

FIG. 16 is a top view of the insert and shield in FIG. 15.

FIG. 17 is a cut away view of another embodiment.

### DETAILED DESCRIPTION OF THE INVENTION

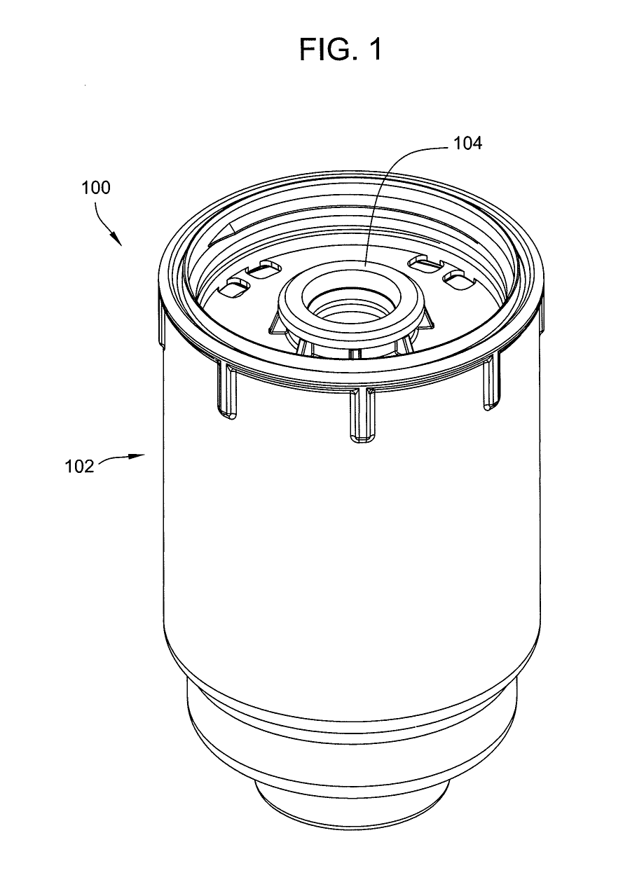

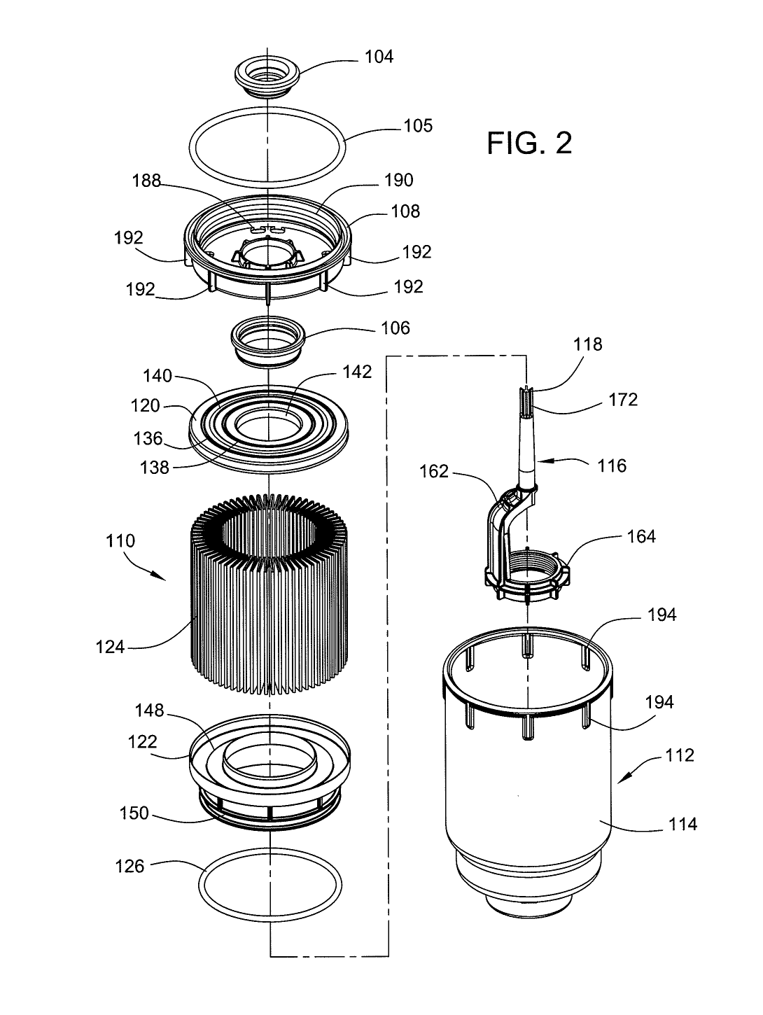

Referring to FIGS. 1 and 2, the filter 100 may include a filter assembly 102, an external grommet 104, and an o-ring 105. As shown in FIG. 2, the filter assembly 102 may include an internal grommet 106, a lid 108, an element assembly 110, and a shell assembly 112. The shell assembly 112 may include a shell 114 and an insert 116. The insert 116 may include a projection 118.

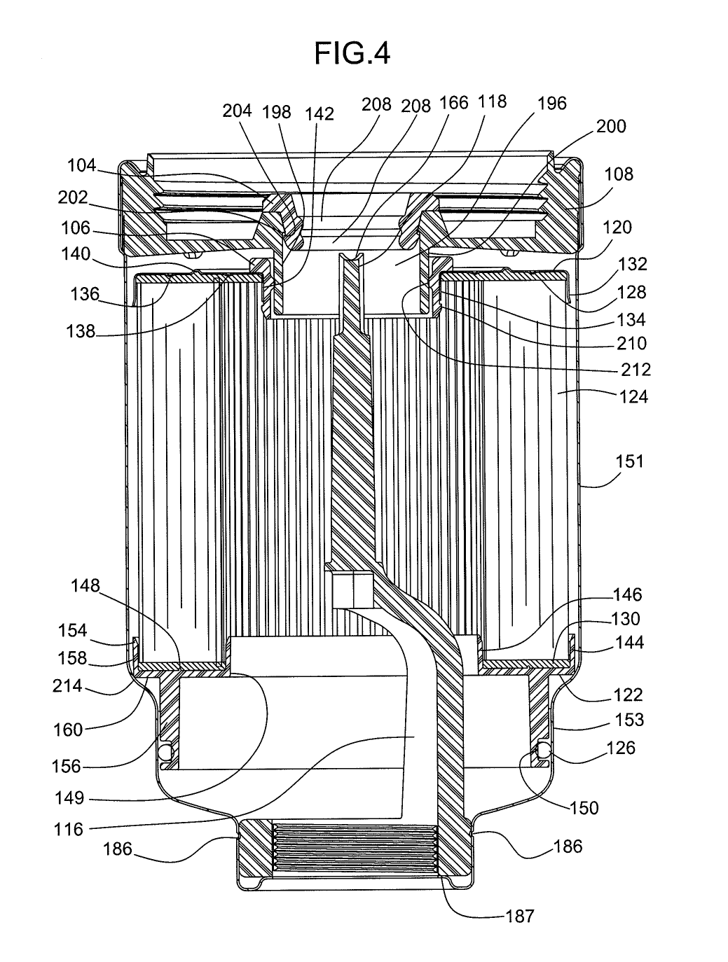

Referring to FIGS. 2 and 4, the element assembly 110 may include a first end cap 120, a second end cap 122, and a filter media 124. The second end cap 122 may include an o-ring 126. Referring to FIG. 4, the first end cap 120 may be attached to the filter media 124 with an adhesive 128 and the second end cap 122 may be attached to the filter media 124 with an adhesive 130. The adhesive may be plastisol. In other embodiments, the adhesive may be epoxy, polyurethane, or hot melt. In other embodiments, the end caps may be attached to the filter media by other techniques, such as, ultrasonic welding, embedding, overmolding, or insert molding. The first end cap 120 may include an outer skirt 132 and an inner skirt 134. The outer and inner skirts may be used to retain the adhesive when the media is positioned in the first end cap. In other embodiments, the first end cap may have an outer skirt but not an inner skirt, an inner skirt but not an outer skirt, or may not have an outer skirt nor an inner skirt.

The first end cap 120 may include standoffs 136, 138. The standoffs may assist in holding the end of the filter media 124 away from the adjacent surfaces of the end cap in order to improve the seal created by the adhesive. The standoffs 136, 138 may have a circular configuration around the first end cap 120, as shown in FIG. 2. In other embodiments, the standoffs may have other configurations, such as, a radial configuration, or a wavy line in a circular configuration. The standoffs may be continuous. In other embodiments, the standoffs may be discontinuous. In other embodiments, the first end cap may have a different number of stand offs, such as one, three, four, or more stand offs. Referring to FIGS. 2 and 4, the first end cap 120 may include an upper rib 140. The upper rib 140 may provide stiffness or rigidity to the first end cap 120. The upper rib 140 may have a circular configuration around the end cap, as shown in FIG. 2. In other embodiments, the upper rib may have other configurations, such as, a radial configuration, or a wavy line in a circular configuration. The upper rib may be continuous. In other embodiments, the upper rib may be discontinuous. In other embodiments, the first end cap may have two, three, four or more upper ribs.

Referring to FIG. 2, the first end cap 120 may include an opening 142. The opening may engage the internal grommet 106, as shown in FIG. 4. The first end cap 120 may be made of metal and may be formed to the particular shape. In other embodiments, the first end cap may be made of other materials, such as, plastic.

Referring to FIG. 4, the second end cap 122 may include an outer skirt 144 and an inner skirt 146. The outer and inner skirts may be used to retain the adhesive when the media is positioned in the second end cap. In other embodiments, the second end cap may have an outer skirt but not an inner skirt, an inner skirt but not an outer skirt, or may not have an outer skirt nor an inner skirt.

Referring to FIG. 4, the second end cap 122 may include a standoff 148. The standoff may assist in holding the end of the filter media 124 away from the adjacent surfaces of the second end cap in order to improve the seal created by the adhesive. The standoff 148 may have a circular configuration around the second end cap 122, as shown in FIG. 2. In other embodiments, the standoff may have another configuration, such as, a radial configuration, or a wavy line in a circular configuration. The standoff may be continuous. In other embodiments, the standoff may be discontinuous. In other embodiments, the second end cap may have a different number of stand offs, such as two, three, four, or more stand offs.

Referring to FIG. 4, the second end cap 122 may have an opening 149. The opening 149 may permit the insert 116 to pass through the second end cap 122. In one embodiment, the insert 116 does not engage the second end cap 122. In addition, the opening 149 may allow contaminants to travel to the bottom of the filter.

The second end cap 122 may have a seal to engage the shell 114. Referring to FIGS. 2 and 4, the seal may be an o-ring 126. The second end cap may have a groove 150. The groove 150 may receive the o-ring 126. The o-ring 126 may engage the shell 114. The seal may be resilient and may deform or deflect to create a seal with the shell 114.

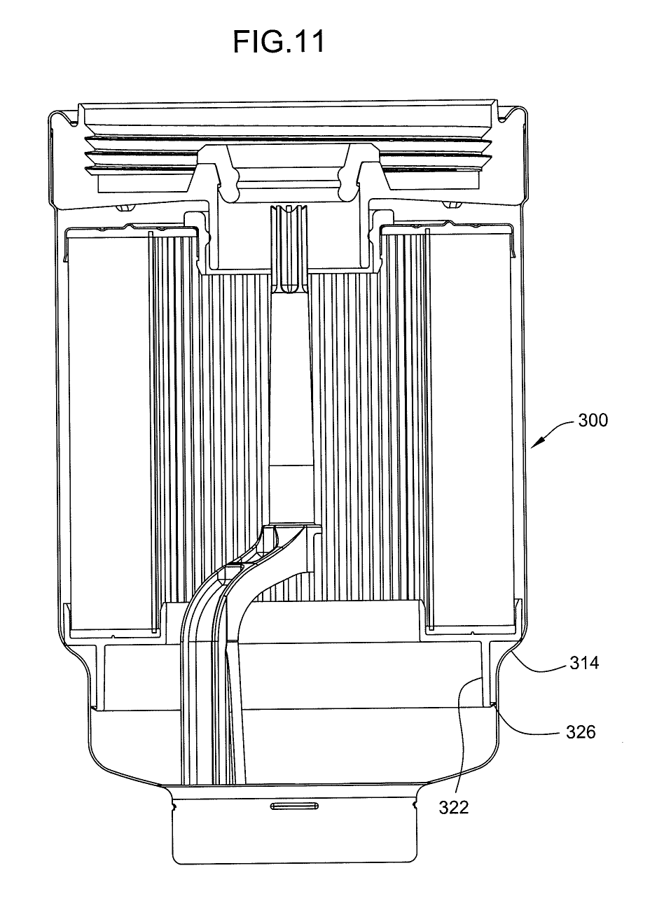

In another embodiment, the seal may be a flange on the second end cap. Referring to FIG. 11, the filter 300 may be similar to the filter 100 except as noted below. The second end cap 322 may have a flange 326. The flange 326 may engage the shell 314. The flange 326 may be resilient and may deform or deflect to create a seal with the shell 314. In one embodiment, the flange 326 may be molded as one piece with the second end cap 322. In other embodiments, the flange and the second end cap may be overmolded or insert molded.

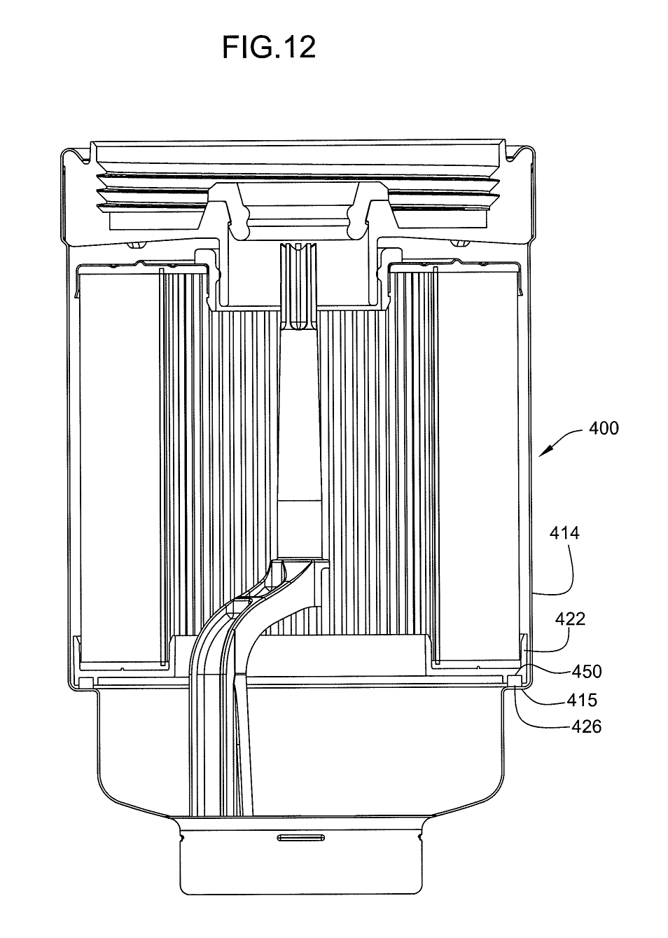

In another embodiment, the seal may be an axial seal on the second end cap. Referring to FIG. 12, the filter 400 may be similar to the filter 100 except as noted below. The second end cap 422 may have a seal 426. The seal 426 may be located in a groove 450. The seal 426 may be resilient and may deform or deflect to create a seal with the shell 414. The seal 426 may engage a ledge 415 on the shell. In one embodiment, the seal 426 may have a rectangular cross-section. In other embodiments, the seal may have other cross-sections, such as, circular, beveled, or trapezoid. The filter may be designed to prevent movement of the element assembly 410 in the axial direction so that the seal 426 remains in contact with the shell 414.

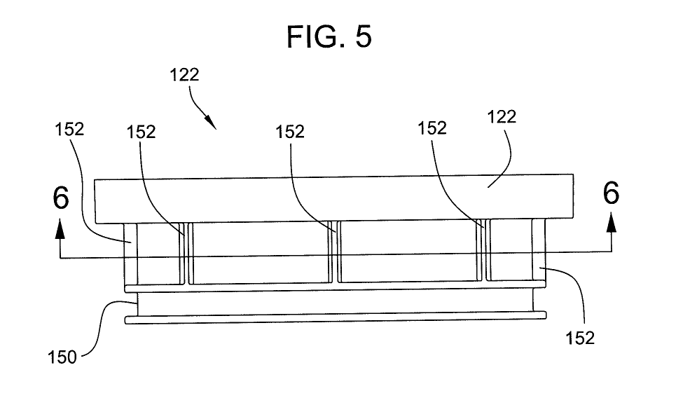

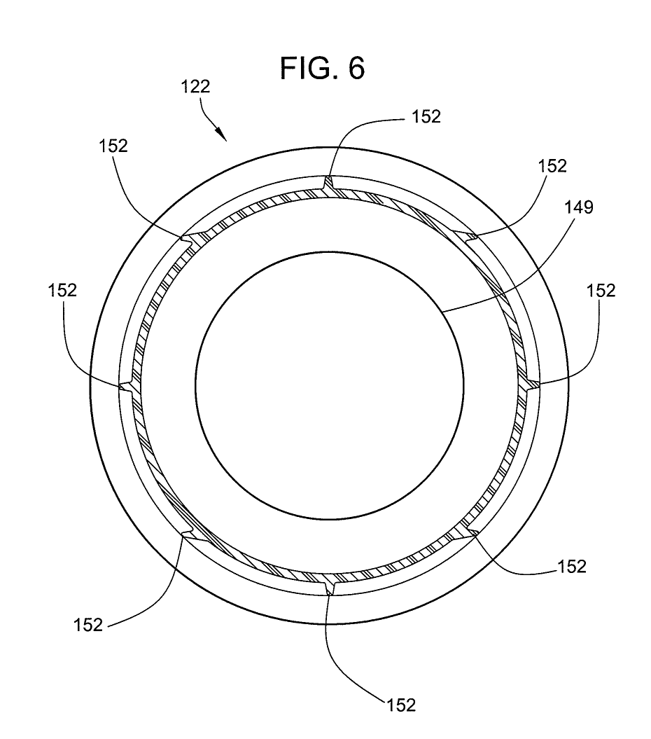

Referring to FIGS. 2 and 5, the second end cap 122 may include ribs 152 above the groove 150. The ribs may assist in the assembly process. The ribs 152 may provide an indication to the assembly personnel that the o-ring 126 is not located in the groove 150. For example, if the o-ring 126 was assembled on the second end cap 122 but positioned in the area of the ribs 152, then the assembly personnel may notice that the o-ring 126 is not located in the groove 150. If the ribs 152 were not present, then the improper location of the o-ring 126 in this area may be less noticeable to the assembly personnel. In addition, if the o-ring 126 was positioned in the area of the ribs 152, then the second end cap 122 may not fit properly in the shell 114. For example, referring to FIG. 4, if the o-ring 126 was positioned in the area of the ribs 152, then the o-ring 126 may not move into the second portion 153 of the shell because the size of the mis-positioned o-ring 126 may be greater than the size of the second portion 153. If the ribs 152 were not present, then the improper location of the o-ring 126 in this area may permit the mis-positioned o-ring 126 to move into the second portion 153 of the shell. In one embodiment, the second portion 153 of the shell may be smaller in size than the first portion 151 of the shell. Referring to FIG. 6, the ribs 152 may be oriented in a manner which facilitates removal from a two part mold. The second end cap 122 may be made from plastic.

The end cap, such as, the second end cap 122, and the seal, such as, the o-ring 126, may be different colors. The end cap may be a first color and the seal may be a second color. For example, the end cap may be a light color and the seal may be a dark color. For example, the end cap may be a white, a cream, or a tan color and the seal may be a black color. The different colors may provide an indication to the assembly personnel that the seal is not located in the groove 150. Also, if a machine vision inspection system is used in the assembly process, the inspection system may be able to detect the improper assembly of the seal on the end cap. In another example, the end cap may have a grey color (such as a recycled plastic) and the seal may have a dark color, such as, a black color. In other embodiments, the end cap may have a dark color and the seal may have a light color. For example, the end cap may be a black color and the seal may be a green, a red, or a yellow color.

Referring to FIG. 4, the second end cap 122 may include a first portion 154 and a second portion 156. The second portion may extend radially inwardly from the outside surface 158 of the first portion to form a ledge 160.

Referring to FIG. 2, the filter media 124 may be a pleated material. In one embodiment, the pleated material may have approximately 65 to 71 pleats with a pleat width of approximately 3.36 inches and a pleat height of approximately 0.709 inches. In other embodiments, the pleated material may have a different number of pleats, pleat width, and/or pleat height. Furthermore, in other embodiments the filter media may be configured as wrapped media, string wound media, or corrugated media. In one embodiment, the pleated material may be from Ahlstrom Corporation, P.O. Box 329, Salmisaarenaukio 1, F1-00101 Helsinki, Finland as part number 98PCFFL-1. In one embodiment, the media may have layers of material. For example, the layers may be, starting from the inside layer to the outside layer: the first layer may be a cellulose blended base sheet; the second layer may be a microglass layer; the third layer may be a spunbonded layer; and the fourth layer may be a spunbonded layer. In other embodiments, the filter media may be made of chemically treated cellulose, melt blown synthetic, spun bonded synthetic, a microglass, or combinations thereof. One example of a filter media is described in U.S. Patent Publication 2009/0178970A1 to Stanfel et al and assigned to Ahlstrom Corporation, which is incorporated herein in its entirety. The filter media may filter particulate matter from the fluid. The filter media may be a coalescing media which may assist in separating water from another liquid, such as, fuel. The fuel may be diesel fuel, or biodiesel fuel.

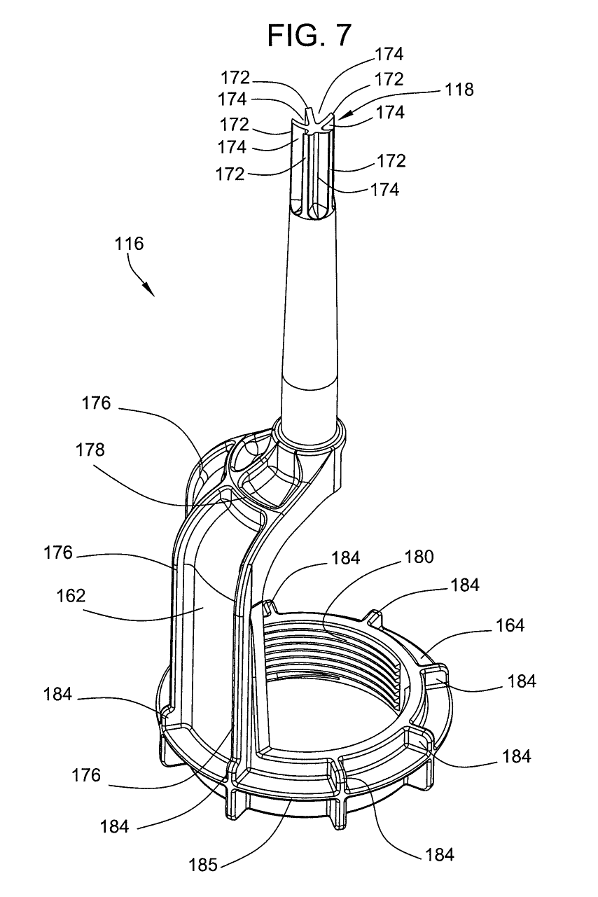

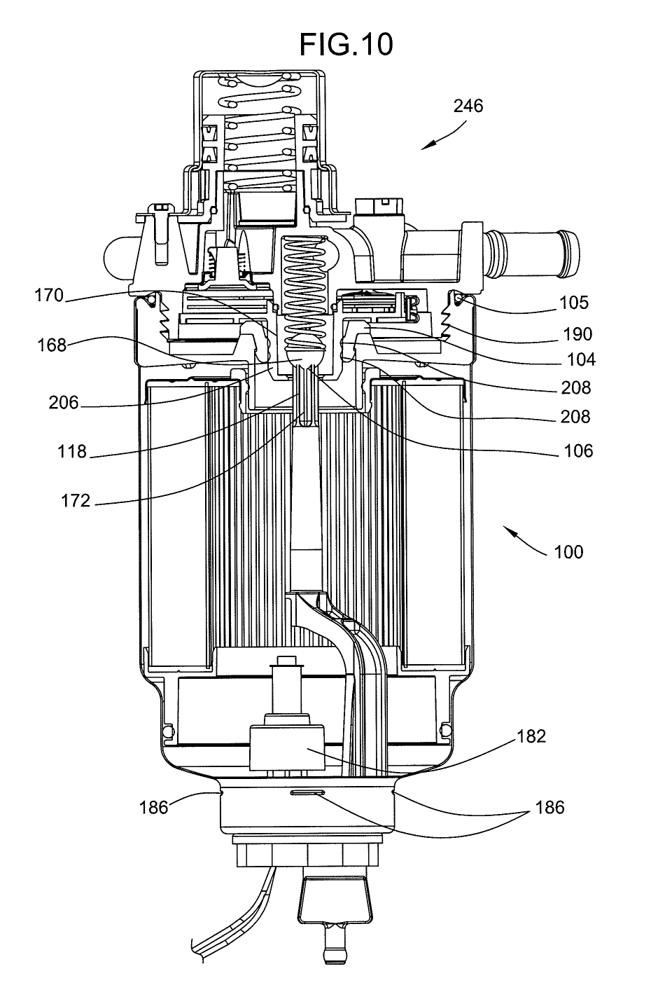

Referring to FIG. 2, the insert 116 may include a projection 118, a leg portion 162, and a lower portion 164. Referring to FIG. 4, the projection 118 may include a curved portion 166. The curved portion 166 may assist in engaging a ball 168 in a valve 170 as shown in FIG. 10. In other embodiments, the projection may not have a curved portion. For example, the end of the projection may be substantially flat, or the end of the projection may have a pointed surface. Referring to FIG. 7, the projection 118 may also include fins 172. In one embodiment, the projection may include five fins. In addition, the spaces 174 between the fins may permit more fluid to flow into the valve than if the spaces did not exist and were occupied with material. In other embodiments, the projection may include one, two, three, four, six or more fins. In other embodiments, the projection may not include fins. For example, the projection may be solid and have a width which is smaller, equal to, or greater than the width of the projection with the fins.

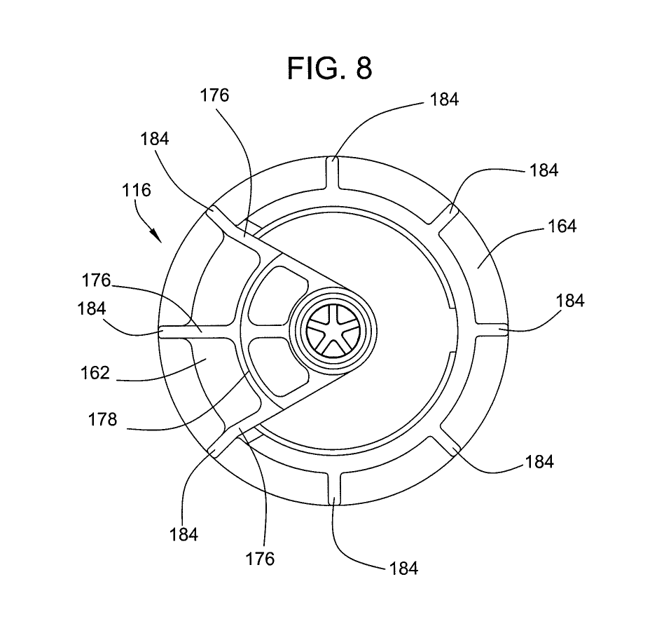

Referring to FIGS. 7 and 8, the leg portion 162 may include vertical support ribs 176. The support ribs 176 may improve the strength of the leg portion without the additional material across the entire leg portion. The leg portion 162 may have three vertical support ribs 176. In other embodiments, the leg portion may have one, two, four, or more support ribs. The leg portion may also include a horizontal support rib 178. The horizontal rib 178 may facilitate the flow of material during the molding process. The horizontal rib 178 may also provide rigidity to the leg portion 162. In other embodiments, the leg portion may have two, three, four or more horizontal support ribs.

Referring to FIG. 7, the lower portion 164 may include threads 180. The threads may receive a water sensor 182 as shown in FIG. 10. Referring to FIG. 7, the lower portion 164 may include one or more outer ribs 184. Referring to FIG. 8, the lower portion 164 may include eight ribs 184. In other embodiments, the lower portion may include one, two, three, four, five, six, seven, nine, or more ribs. The ribs 184 may increase the strength of the lower portion 164. Referring to FIGS. 4 and 10, the ribs 184 may also be used to engage the retention portions 186 of the shell in order to reduce rotation of the lower portion 164 relative to the shell 114. The retention portions may be created by deforming the shell, such as, by staking. In one embodiment, the shell 114 may have four retention portions 186. In other embodiments, the shell may have one, two, three, five, or more retention portions.

Referring to FIG. 7, the lower portion 164 may include a rib 185. The rib 185 may extend around the outer surface of the lower portion 164. Referring to FIG. 4, when the insert 116 is positioned in the shell 114, the insert 116 may engage a lip 187 on the shell. The retention portion 186 may engage the insert 116, such as, the upper surface of the rib 185. The engagement with the retention portion may assist in retaining the insert 116 to the shell 114 and may assist in preventing upward movement of the insert 116 with respect to the shell 114. The engagement may also assist in reducing rocking movement, and/or side to side movement of the insert 116 with respect to shell 114 so that the projection 118 can maintain the proper alignment with the outlet opening 196 as shown in FIG. 4. In another embodiment, the insert 116 may be attached to the shell 114 by other techniques, such as, by using an adhesive. The insert 116 may be made of plastic, such as, glass filled nylon. In other embodiments, the insert may be made of other plastics, such as, nylon, high density polyethylene (HDPE), or polyethylene terephthalate (PET), or combinations thereof. In other embodiments, the insert may be made of metal, such as, die cast aluminum. In other embodiments, the insert may be made of combinations of plastic and metal.

Referring to FIG. 4, in one embodiment, the projection 118 is not part of the first end cap 120 or the second end cap 122. In addition, in one embodiment, the projection 118 is not connected to or attached to the first end cap 120 or the second end cap 122. Furthermore, in one embodiment, the projection 118 does not engage the first end cap 120 or the second end cap 122.

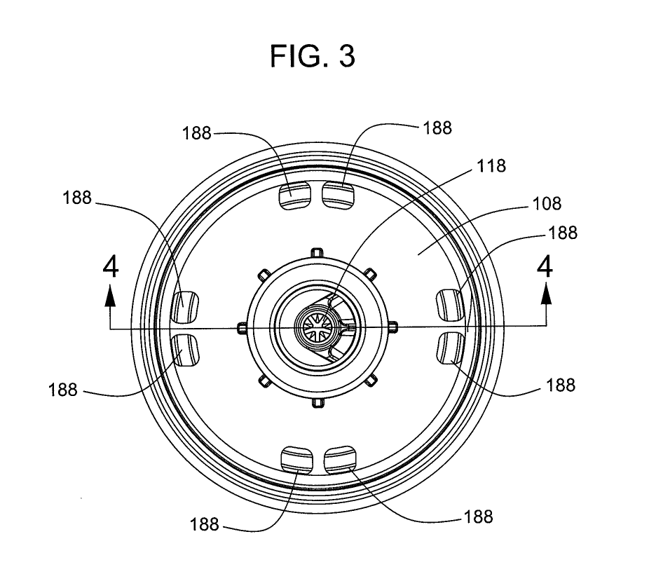

Referring to FIGS. 2 and 3, the lid 108 may include one or more inlet openings 188. In one embodiment, the lid may include eight inlet openings. In other embodiments, the lid may include a different number of inlet openings. The lid 108 may also include threads 190. The threads 190 may be used to engage threads on the filter head 246 as shown in FIG. 10. Referring to FIG. 2, the lid 108 may include one or more outer ribs 192. The outer ribs 192 may be used to engage detents 194 in the shell 114. The engagement of the ribs 192 with the detents 194 may prevent rotation between the lid 108 and the shell 114. In one embodiment, the lid may include eight ribs. In other embodiments, the lid may include a different number of ribs, such as, one, two, three, four, five, six, seven, nine, or more ribs.

Referring to FIG. 4, the lid 108 may include an outlet opening 196. The outlet opening 196 may have an inner surface 198 and an outer surface 200. The inner surface 198 may engage the external grommet 104. In order to retain the external grommet 104 to the lid 108, the inner surface may include a ledge 202 which may engage a ledge 204 on the grommet 104. In other embodiments, different techniques may be used to retain the external grommet to the lid. The external grommet 104 may engage the nipple 206 on the filter head as shown in FIG. 10. Referring to FIG. 4, the external grommet 104 may include one or more ribs 208. The ribs 208 may assist in providing a seal with respect to the nipple 206 on the filter head as shown in FIG. 10. In one embodiment, the grommet may include two ribs. In other embodiments, the grommet may include one, three, four, or more ribs.

Referring to FIG. 4, the outer surface 200 of the outlet opening 196 may engage the internal grommet 106. The internal grommet 106 may include a ledge 210. The ledge 210 may engage the first end cap 120 in order to assist in retaining the internal grommet 106 with respect to the first end cap 120. The internal grommet 106 may include a rib 212 on the interior surface. The rib 212 may be used to assist in providing a seal with the outer surface 200 of the outlet opening 196. In other embodiments, the internal grommet may include two, three, or more internal ribs.

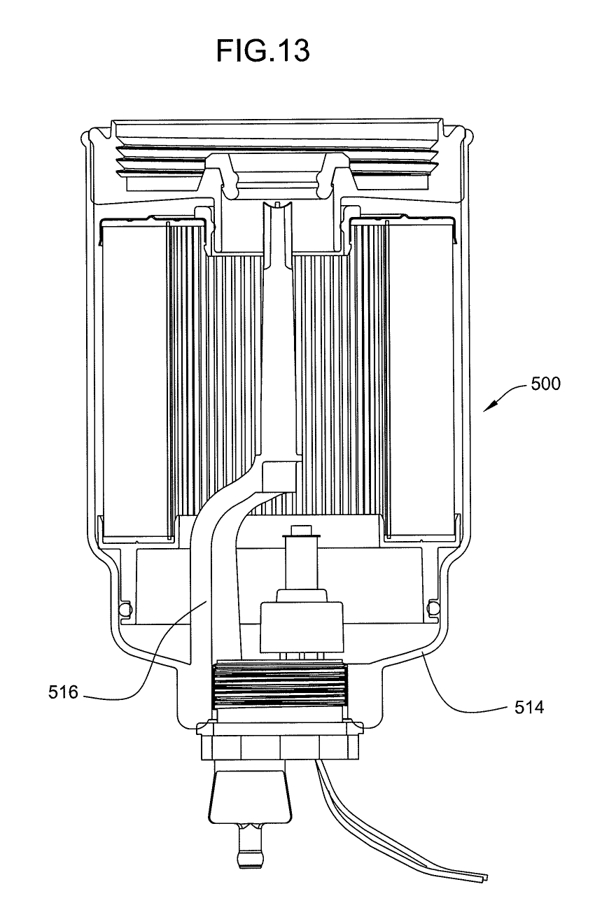

Referring to FIG. 2, the shell 114 may include one or more detents 194. The detents 194 may be used to engage the outer ribs 192 on the lid 108. The ribs and detents may assist in preventing rotation between the lid 108 and the shell 114. In one embodiment, the shell may include eight detents. In other embodiments, the shell may include a different number of detents, such as, one, two, three, four, five, six, seven, nine, or more detents. In one embodiment, the shell may be made of metal, such as, tin plated steel, aluminum, or stainless steel. The metal may have a coating, such as, an epoxy coating if appropriate. In other embodiments, the shell may be made of plastic, such as, nylon, high density polyethylene (HDPE), polyethylene terephthalate (PET), or combinations thereof. In one embodiment, the shell and the insert may be molded from plastic. The shell and insert may be molded as one piece, may be overmolded, or may be insert molded. For example, referring to FIG. 13, the filter 500 may be similar to filter 100 except that the shell 514 and the insert 516 may be molded as one piece.

Referring to FIG. 4, the shell may include a ledge 214. The element assembly 110 may move in the longitudinal direction with respect to the shell 114. The ledge 214 may act as a stop for the second end cap 122 to assist in preventing downward movement of the element assembly 110. The bottom of the lid 108 may act as a stop to assist in preventing the upward movement of the element assembly 110 when the internal grommet 106 engages the lid 108. The o-ring 126 may assist in providing a seal between the second end cap 122 and the side wall of the shell 114.

The filter assembly 100 may be assembled in the following manner. Referring to FIGS. 2 and 4, the insert 116 may be positioned into the shell 114. The shell 114 may be deformed at the retention portions 186, such as, by staking. The element assembly 110 may be inserted into the shell 114. The o-ring 126 may engage the sidewall of the shell 114. The internal grommet 106 may be assembled to the opening 142 on the first end cap 120. The lid 108 may be inserted into the shell 114. The top 216 of the shell 114 may be deformed over the lid 108 to hold the lid onto the shell. The external grommet 104 may be positioned in the outlet opening 196 on the lid 108.

In another assembly method, some of the steps may be different. After the insert 116 is attached to the shell 114, the internal grommet 106 may be assembled to the opening 142 on the first end cap 120 of the element assembly 110. The lid 108 may be inserted into the internal grommet 106 on the element assembly 110. The combination of the internal grommet 106, the lid 108 and the element assembly 110 may be inserted into the shell. The top 216 of the shell 114 may be deformed over the lid 108.

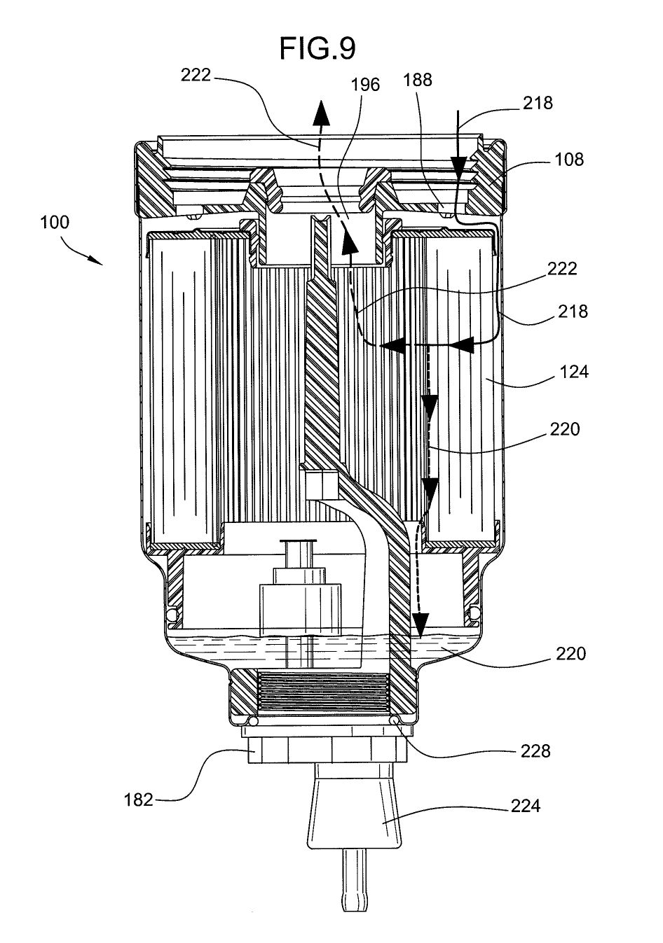

Referring to FIG. 9, the filter 100 may operate in the following manner. The fuel and water mixture 218 may enter the filter 100 through the openings 188 in the lid 108. The fuel and water mixture 218 may travel through the filter media 124. The filter media 124 may facilitate the separation of the water 220 from the fuel 222. The water 220 may sink to the bottom of the filter and may remain at the bottom of the filter until the water 220 is drained through a drain valve 224. The fuel 222 may flow upward and through the outlet opening 196 in the filter.

FIG. 10 shows the filter 100 installed on a filter head 226, the projection 118 may open the valve 170 in the filter head. More specifically, the curved portion 166 of the projection may engage the curved surface of the ball 168 in the valve 170. The ball 168 may move upward against the spring and the ball 168 may unseat from the seating surface on the valve. Fuel may flow around the projection 118 and between the fins 172 of the projection 118 into the valve. The external grommet 104 may create a seal with the nipple 206 on the filter head. In addition, the o-ring 126 may create a seal on the filter head. A water sensor 182 may be installed onto the filter 100. Referring to FIG. 9, the water sensor 182 may include a seal 228, such as, an o-ring, to create a seal between the water sensor 182 and the filter 100.

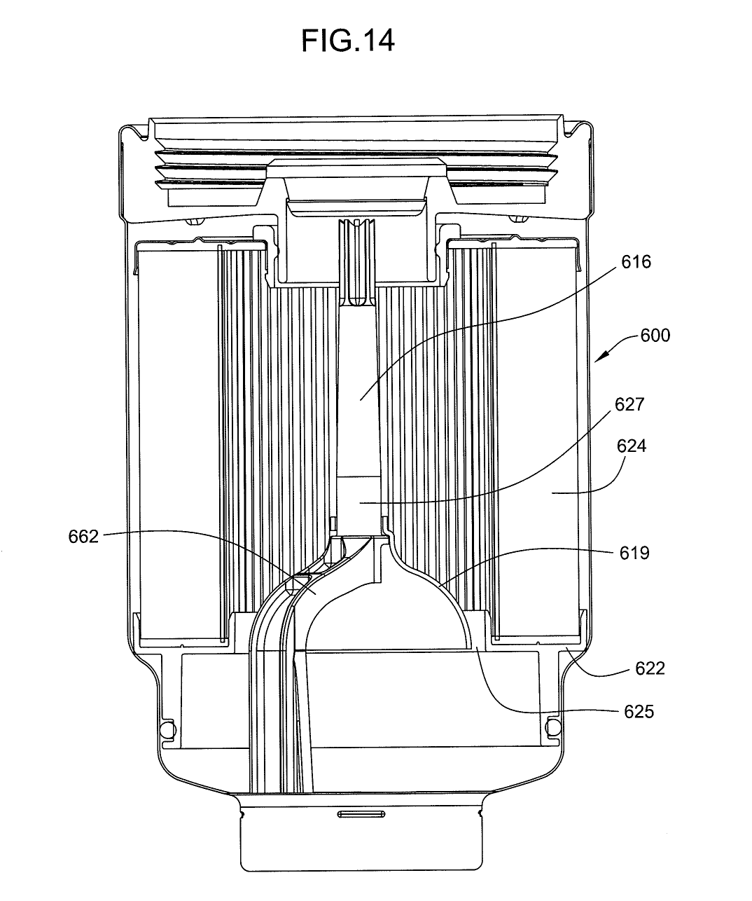

Referring to FIG. 14, another embodiment of a filter is shown. The filter 600 may be similar to filter 100 except as noted below. The filter 600 may include a shield 619. The shield 619 may prevent the water which has collected at the bottom of the filter from moving upward. In one embodiment, the shield 619 may have a domed shape. In other embodiments, the shield may have other shapes, such as, a conical shape, a flat shape, or a pyramid shape. The shield 619 may be spaced away from the second end cap 622 and the filter media 624 to create a gap 625. The gap 625 may permit the water which coalesces on the filter media to travel downward through the gap 625. The water may then collect at the bottom of the filter 600. However, the size of the gap is small enough to assist in preventing a significant portion of the water at the bottom of the filter from moving upward. The shield 619 may be connected to the insert 616. The shield 619 may be attached to the insert 616 by a friction fit, adhesive, ultrasonic welding, or mechanical attachment, such as, a rib on the insert, or a hook on the shield which engages a portion of the insert. The insert 616 may have a cylindrical portion 627 which may facilitate with the attachment. In other embodiments, the shield may be in other locations. In other embodiments the shield may be connected to other parts. For example, the shield may be attached to the second end cap or the filter media. In other embodiments, the shield may or may not be attached to the insert.

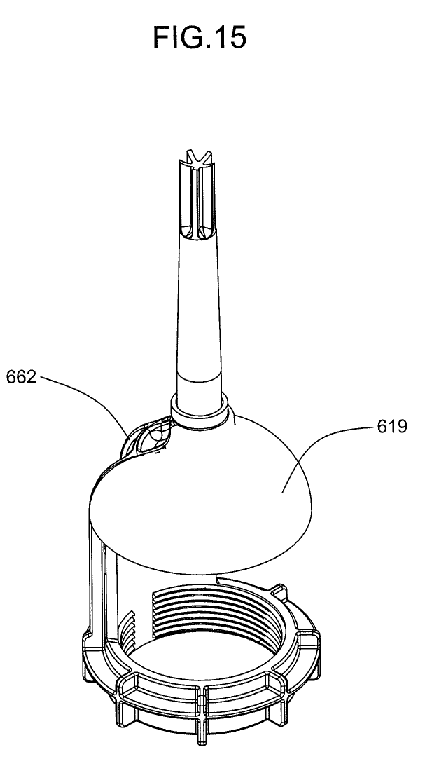

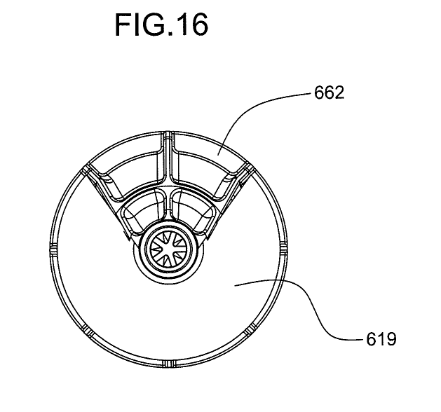

Referring to FIGS. 15 and 16, the shield 619 may extend around the insert. The shield 619 may engage the sides of the leg portion 662 on the insert. The shield may extend approximately 301 degrees around the insert. The leg portion 662 of the insert may act as a shield in the remaining 59 degrees. In other embodiments, the angles of the shield and insert may be different combinations of angles. In other embodiments, the shield may extend 360 degrees around the insert. The shield may be made of plastic, metal, or another material, such as, a hydrophobic material.

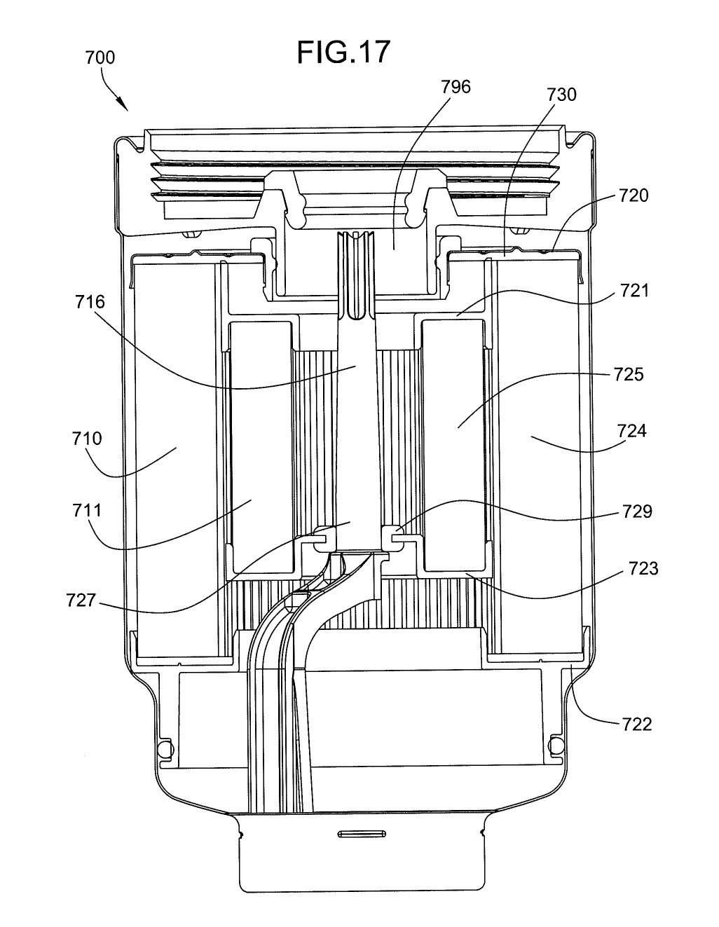

Referring to FIG. 17, another embodiment of a filter is shown. The filter 700 may be similar to filter 100 except as noted below. The filter 700 may include a first element assembly 710 and a second element assembly 711. The first element assembly 710 may include a first end cap 720, a second end cap 722, and a first filter media 724. The second element assembly 711 may include a third end cap 721, a fourth end cap 723, and a second filter media 725. The third end cap 721 may be connected to the first end cap 720. The third end cap 721 may be attached to the first end cap 720 with the adhesive 730. In other embodiments, the third end cap 721 may be attached to the first end cap 720 with a mechanical attachment. In other embodiments, the third end cap 721 and the first end cap 720 may be molded as one piece, may be overmolded, or may be insert molded. The third end cap 721, the fourth end cap 723, and the second filter media 725 may be connected in the manners described herein with respect to the first element assembly 110.

The fourth end cap 723 may include a seal 729. The seal 729 may engage the insert 716. In one embodiment, the seal 729 may engage the cylindrical portion 727 of the insert 716. The seal 729 may have a groove which may engage an edge of the fourth end cap 723. In other embodiments, the seal and the fourth end cap may be overmolded or insert molded. In other embodiments, the seal may be a flange which may be molded as one piece with the fourth end cap. In other embodiments, the seal may be attached to the fourth end cap with a press fit, an adhesive, or ultrasonic welding.

The filter media 725 may provide additional filtration of contaminants, such as, particulate matter and undesirable fluids. The filter media 725 may have a construction similar to the filter medias described herein with respect to filter media 124. The filter media 725 may also have an outer layer which prevents the entry of water droplets. For example, the outer layer may be a hydrophobic layer, such as, a silicone treated media, or a silicone coated nylon screen. The outer layer may assist in preventing the water which has collected at the bottom of the filter from moving upward into the outlet opening 796.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A filter for filtering fluids, the filter capable of mounting to a filter head which includes a valve, the filter comprising a first end cap, a second end cap, a filter media located between the first end cap and the second end cap, a shell, a projection, the projection capable of engaging a valve in a filter head, the projection connected to the shell, the projection is without connection to the first end cap, the projection is without connection to the second end cap.

2. The filter as in claim 1 further comprising an insert, the projection is connected to the insert.

3. The filter as in claim 2 wherein the insert includes a leg portion and a lower portion.

4. The filter as in claim 3 wherein the lower portion includes threads.

5. The filter as in claim 1 wherein the projection and the shell are molded as one piece.

6. The filter as in claim 1 further comprising a shield.

7. The filter as in claim 1 wherein the insert includes ribs.

8. The filter as in claim 1 wherein the projection includes a curved portion.

9. The filter as in claim 1 wherein the projection includes a fin.

10. The filter as in claim 1 further comprising a lid, the lid connected to the shell.

11. The filter as in claim 1 wherein the filter media is a ring of filter media.

12. The filter as in claim 1 wherein the second end cap includes a seal.

13. The filter as in claim 12 wherein the seal is a radial seal.

14. The filter as in claim 13 wherein the seal is an o-ring.

15. The filter as in claim 13 wherein the seal is a flange.

16. The filter as in claim 12 wherein the seal is an axial seal.

17. The filter as in claim 1 further comprising a third end cap, a fourth end cap, a second filter media located between the third end cap and the fourth end cap.

18. A filter for filtering fluids, the filter capable of mounting to a filter head which includes a valve, the filter comprising a first end cap, a second end cap, a filter media located between the first end cap and the second end cap, a shell, a projection, the projection capable of engaging a valve in a filter head, the projection includes a curved portion, the curved portion capable of engaging a curved portion of the valve.

19. The filter as in claim 18 wherein the projection includes a fin.

20. The filter as in claim 18 further comprising a lid, the lid connected to the shell.

21. The filter as in claim 18 wherein the filter media is a ring of filter media.

22. The filter as in claim 18 further comprising an insert, the projection is connected to the insert.

23. The filter as in claim 22 wherein the insert includes a leg portion and a lower portion.

24. A filter for filtering fluids, the filter capable of mounting to a filter head, the filter comprising a first end cap, a second end cap, a filter media located between the first end cap and the second end cap, a shell, a shield, an outlet, the shield preventing contaminants from exiting the outlet.

25. The filter as in claim 24 wherein the filter media is a coalescing media.

26. The filter as in claim 24 wherein the shield is spaced from the filter media to form a gap.

27. The filter as in claim 24 wherein the shield has a domed shape.

28. A filter for filtering fluids, the filter capable of mounting to a filter head, the filter comprising a first end cap, a second end cap, a filter media located between the first end cap and the second end cap, a shell, a seal, the second end cap includes a groove for the seal, the second end cap includes a rib in proximity to the groove.

29. The filter as in claim 28 wherein the second end cap includes a plurality of ribs.

30. The filter as in claim 28 wherein the rib provides an indication that the seal is located on the ribs.

31. A filter for filtering fluids, the filter capable of mounting to a filter head, the filter comprising a first end cap, a second end cap, a filter media located between the first end cap and the second end cap, a shell, a seal, the second end cap includes a groove for the seal, the second end cap is a first color, and the seal is a second color.

32. The filter as in claim 31 wherein the first color is a light color and the second color is a dark color.

33. The filter as in claim 31 wherein the first color is a dark color and the second color is a light color.
